(19) United States
(12) Patent Application Publication
(10) Pub. No.: US 2023/0359198 A1
(43) Pub. Date: Nov. 9, 2023

(54) UNMANNED AERIAL VEHICLE, CONTROL METHOD THEREOF, AND STORAGE MEDIUM

(71) Applicant: SZ DJI TECHNOLOGY CO., LTD., Shenzhen (CN)

(72) Inventor: Litian ZHANG, Shenzhen (CN)

(21) Appl. No.: 18/343,369

(22) Filed: Jun. 28, 2023

Related U.S. Application Data
(63) Continuation of application No. PCT/CN2020/141085, filed on Dec. 29, 2020.

(51) Int. Cl. G05D 1/00; B64U 10/14; G05D 1/08

(52) U.S. Cl. CPC G05D 1/0038; B64U 10/14; G05D 1/0808; B64U 2101/30

(57) ABSTRACT

A control method for an aerial vehicle includes obtaining a control stick value sent by a control device that is in communication connection with the aerial vehicle, determining, according to the control stick value, a target image region in a panoramic image captured by one or more photographing devices carried by the aerial vehicle, and sending the target image region to the control device, to enable the control device to display the target image region.

### CROSS-REFERENCE TO RELATED APPLICATION

This application is a continuation of International Application No. PCT/CN2020/141085, filed Dec. 29, 2020, the entire content of which is incorporated herein by reference.

### TECHNICAL FIELD

The present disclosure relates to the field of unmanned aerial vehicles and, more particularly, to an unmanned aerial vehicle, a control method thereof, and a storage medium.

### BACKGROUND

In recent years, flight with first-person view (FPV) of unmanned aerial vehicles has become more and more popular, and its immersive flight experience has attracted the attention of many people. However, the operation difficulty of flight with FPV is very high, requiring a user to operate the unmanned aerial vehicles to perform fancy flying movements to capture thrilling and exciting images. The existing technology provides a solution based on a panoramic camera. The panoramic camera is arranged on an unmanned aerial vehicle, and the panoramic video is captured by the panoramic camera during the flight of the unmanned aerial vehicle. The user edits the panoramic video using a video post-production software and cuts out the video effect that the user wants.

However, this post-production method is not able to allow the user to view thrilling and exciting pictures in real time during the flight of the unmanned aerial vehicle, and it is still difficult to meet the needs of the user.

### SUMMARY

In accordance with the disclosure, there is provided a control method for an aerial vehicle including obtaining a control stick value sent by a control device that is in communication connection with the aerial vehicle, determining, according to the control stick value, a target image region in a panoramic image captured by one or more photographing devices carried by the aerial vehicle, and sending the target image region to the control device, to enable the control device to display the target image region.

Also in accordance with the disclosure, there is provided an aerial vehicle including one or more photographing device configured to capture a panoramic image, a memory storing a computer program, and a processor configured to execute the computer program to obtain a control stick value sent by a control device in communication connection with the aerial vehicle, determine a target image region in the panoramic image according to the control stick value, and send the target image region to the control device, to enable the control device to display the target image region.

### BRIEF DESCRIPTION OF THE DRAWINGS

FIG. 1 is a schematic flow chart of a control method of an unmanned aerial vehicle consistent with the present disclosure.

FIG. 2 is a diagram schematically showing a field of view (FOV) of a fisheye photographing device arranged above an unmanned aerial vehicle consistent with the present disclosure.

FIG. 3 is a diagram schematically showing an FOV of a fisheye photographing device arranged under an unmanned aerial vehicle consistent with the present disclosure.

FIG. 4 is a diagram schematically showing a spliced FOV of two fisheye photographing devices arranged above and under an unmanned aerial vehicle consistent with the present disclosure.

FIG. 5 is a schematic structural diagram showing a scenario in which arms and photographing devices of an unmanned aerial vehicle are extended consistent with the present disclosure.

FIG. 6 is a schematic structural diagram showing a scenario in which arms and photographing devices of an unmanned aerial vehicle are folded consistent with the present disclosure.

FIG. 7 is a schematic flow chart of another control method of an unmanned aerial vehicle consistent with the present disclosure.

FIG. 8 is a schematic diagram showing determination of a target image region in a control method of an unmanned aerial vehicle consistent with the present disclosure.

FIG. 9 is a schematic flow chart of another control method of an unmanned aerial vehicle consistent with the present disclosure.

FIG. 10 is a schematic structural diagram of a joystick of a remote controller used in a control method of an unmanned aerial vehicle consistent with the present disclosure.

FIG. 11 is a schematic diagram showing determination of a yaw offset angle in a control method of an unmanned aerial vehicle consistent with the present disclosure.

FIG. 12 is a schematic diagram showing a virtual camera coordinate system in a control method of an unmanned aerial vehicle consistent with the present disclosure.

FIG. 13 is a schematic diagram of an unmanned aerial vehicle consistent with the present disclosure.

### REFERENCE NUMERALS

100—Unmanned aerial vehicle, 1—Memory, 2—Processor, 3—Photographing device, 10—First arm, 20—Second arm, 30—Rotation shaft.

### DETAILED DESCRIPTION OF THE EMBODIMENTS

The technical solutions of the present disclosure will be described below in conjunction with the drawings in the embodiments of the present disclosure. Obviously, the described embodiments are just some of the embodiments of the present disclosure, but not all of the embodiments. Based on the embodiments in this disclosure, all other embodiments obtained by those of ordinary skill in the art without creative work shall fall within the scope of this disclosure.

The flow charts shown in the drawings are just illustrations, and do not necessarily include all contents and operations/steps, nor must they be performed in the order described. For example, some operations/steps can be decomposed, combined or partly combined, so the actual order of execution may be changed according to the actual situation.

The embodiments of the present disclosure will be described below in conjunction with the drawings in the embodiments of the present disclosure. In the case of no conflict, the following embodiments and features in the embodiments may be combined with each other.

In recent years, flight with first-person view (FPV) of unmanned aerial vehicles has become more and more popular, and its immersive flight experience has attracted the attention of many people. However, the operation difficulty of flight with FPV is very high, requiring a user to operate the unmanned aerial vehicle to perform fancy flying movements to capture thrilling and exciting pictures. The existing technology provides a solution based on a panoramic camera. The panoramic camera is arranged on an unmanned aerial vehicle, and the panoramic video is captured by the panoramic camera during the flight of the unmanned aerial vehicle. The user edits the panoramic video using a video post-production software and cuts out the video effect that the user wants. However, this post-production method is not able to allow the user to view thrilling and exciting pictures in real time during the flight of the unmanned aerial vehicle, and it is still difficult to meet the needs of the user.

The present disclosure provides an unmanned aerial vehicle, a control method thereof, and a storage medium. The unmanned aerial vehicle may be provided with photographing devices for capturing a panoramic image. The unmanned aerial vehicle may be in communication connection with a control device, to obtain a control stick value sent by the control device. A target image region in the panoramic image captured by the photographing devices may be determined according to the control stick value. Then the target image region may be sent to the control device, such that the control device displays the target image region. Since the unmanned aerial vehicle and the control device are in communication connection, the control device may send the control stick value, and the unmanned aerial vehicle may determine the target image region in the panoramic image captured by the photographing devices according to the obtained control stick value, and send the target image region to the control device, to cause the control device to display the target image region. Therefore, the unmanned aerial vehicle may be able to determine the target image region in the panoramic image in time according to the control stick value sent by the control device, and return the target image region to the control device, to provide technical support for a user to view a scene corresponding to the control stick value in real time. When receiving the target image region, the control device may display the target image region in time, and the user may be able to view the scene corresponding to the control stick value in real time, such as various thrilling and exciting scenes. Therefore, the user's needs may be satisfied, and the user experience may be improved.

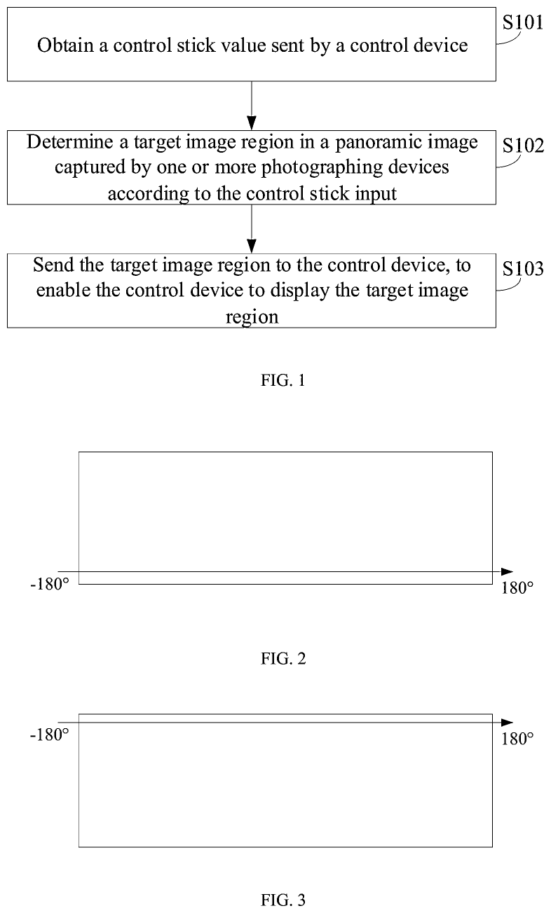

The present disclosure provides a control method of an unmanned aerial vehicle. FIG. 1 is a schematic flow chart of a control method of an unmanned aerial vehicle provided by one embodiment of the present disclosure. In the present disclosure, unmanned aerial vehicle and control method of unmanned aerial vehicle are described as examples. The subject of the present disclosure can also be any movable object, such as an aerial vehicle, and the control method consistent with the present disclosure can also be applied to such movable object such as aerial vehicle.

The unmanned aerial vehicle may be provided with one or more photographing devices for capturing a panoramic image. In some embodiments, the unmanned aerial vehicle may be provided with a plurality of photographing devices and the panoramic image may be formed by splicing images captured by the plurality of photographing devices. In an actual application process, the number of photographing devices that are needed depends on the fields of view (FOVs) of the selected photographing devices and the required splicing quality. The smaller the FOV of each camera, the more photographing devices may be needed to achieve 360° full coverage.

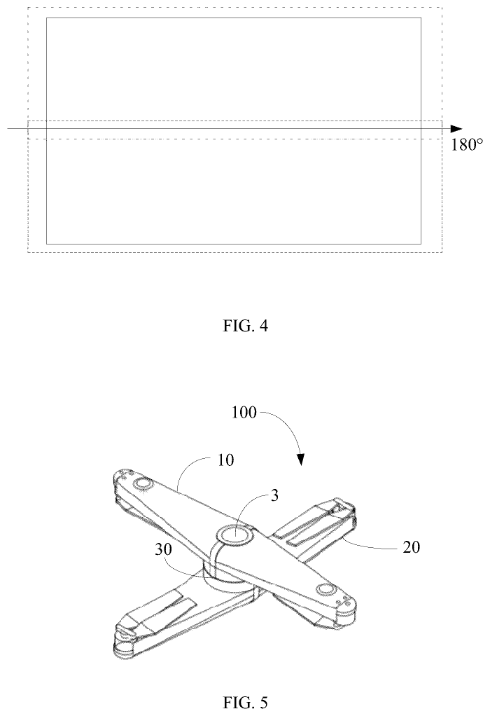

For example, the photographing devices may include two fisheye photographing devices which are respectively arranged above and below the unmanned aerial vehicle, and each fisheye photographing device may cover more than ½ of the FOV of the panoramic image. The FOVs of the two fisheye photographing devices may partially overlap each other. As shown in FIG. 2 and FIG. 3, the FOV of a fisheye photographing device is represented by a solid line box in the figures. As shown in FIG. 4, the FOVs of the two fisheye photographing devices are represented by upper and lower dashed line boxes in the figure, respectively, and the FOV of the combination of the two fisheye photographing devices is represented by a solid line box in the figure. The images captured by the two fisheye photographing devices may be spliced to obtain the panoramic image covered by the combined FOV.

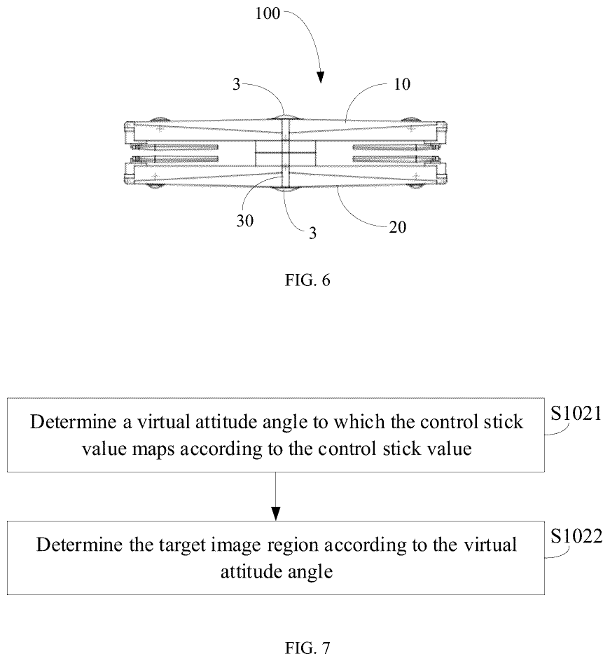

As shown in FIG. 5 and FIG. 6, in some embodiments, the unmanned aerial vehicle 100 includes a first arm 10 and a second arm 20. The second arm 20 is connected to the first arm 10 through a rotation shaft 30, and the two ends of the rotation shaft 30 are provided with the photographing devices 3. The photographing devices 3 may be fisheye photographing devices. Since the second arm 20 is connected to the first arm 10 through the rotation shaft 30 and the photographing devices 3 are arranged at both ends of the rotation shaft 30, when the second arm 20 of the unmanned aerial vehicle 100 rotates relatively with respect to the first arm 10, the photographing devices 3 arranged at the two ends of the rotation shaft 30 does not change in relative position. Therefore, there is no need to re-calibrate the relative position when the photographing devices 3 perform panoramic photographing. The splicing speed and the splicing accuracy of the panoramic image may be ensured.

In some embodiments, the control method of the unmanned aerial vehicle includes S101, S102, and S103, as described in more detail below.

At S101, a control stick value sent by a control device is obtained.

At S102, a target image region in a panoramic image captured by one or more photographing devices is determined according to the control stick value.

At S103, the target image region is sent to the control device, such that the control device displays the target image region.

In some embodiments, the unmanned aerial vehicle may be in communication connection with the control device. The control device may be a device that is able to send control commands that is able to be responded by the unmanned aerial vehicle. The control device may be, but is not limited to: a remote controller, a user apparatus, a terminal apparatus, etc. The control device may be also a combination of two or more control devices, such as a remote controller and a user apparatus, a remote controller and a terminal apparatus, and so on.

The control stick value may be a control instruction for determining the target image region in the panoramic image captured by the photographing devices. The control stick value may be issued by the user by pushing the joystick, or by touching the joystick on the touch screen, or directly by inputting instructions, and so on. According to the control stick value, there may be many ways to determine the target image region in the panoramic image captured by the photographing devices. For example, the panoramic image may be divided into a plurality of image regions in advance and a correspondence relationship between a preset control stick value and the preset panoramic image regions may be configured in advance. Therefore, the target image region may be determined according to the control stick value sent by the control device and the correspondence relationship. In another example, the control stick value may map to a virtual attitude angle, and the target image region may be determined according to the virtual attitude angle.

The target image region may be sent to the control device, such that the control device displays the target image region. The user may be able to view the scene corresponding to the control stick value in real time, such as various thrilling and exciting scenes. Therefore, the user's needs may be satisfied, and the user experience may be improved.

In the present disclosure, the unmanned aerial vehicle may be provided with the photographing devices for capturing the panoramic image. The unmanned aerial vehicle may be in communication connection with the control device. The control stick value sent by the control device may be obtained. The target image region in the panoramic image captured by the photographing devices may be determined according to the control stick value. The target image region may be sent to the control device, such that the control device displays the target image region. Since the unmanned aerial vehicle may be in communication connection with the control device and the control device may issue the control stick value, the unmanned aerial vehicle may determine the target image region in the panoramic image captured by the photographing devices according to the control stick value, and send the target image region to the control device, such that the control device displays the target image region. Therefore, the unmanned aerial vehicle may be able to determine the target image region in the panoramic image captured by the photographing devices according to the control stick value issued by the control device and send the target image region back to the control device. Therefore, technical support may be provided to the user for viewing the images corresponding to the control stick value in real time (especially when the user views the images corresponding to the control stick value in real time during the flight process of the unmanned aerial vehicle). The control device may be able to display the target image region in time when receiving the target image region, and the user may be able to view the images corresponding to the control stick value in real time (especially when the user views the images corresponding to the control stick value in real time during the flight process of the unmanned aerial vehicle), such as various thrilling and exciting scenes. Therefore, the user's needs may be satisfied, and the user experience may be improved.

The application of the method in the embodiments of the present disclosure in various specific application scenarios is described in detail below.

In some embodiments, the method provided by the present disclosure may be applied in an application scenario involving an unmanned aerial vehicle, a remote controller, and a head-mounted display device. That is, the control device may include the remote controller and the head-mounted display device. In this scenario, obtaining the control stick value sent by the control device (S101) may include: obtaining the control stick value sent by the remote controller. Correspondingly, sending the target image region to the control device such that the control device displays the target image region (S103) may include: sending the target image region to the head-mounted display device, such that the head-mounted display device displays the target image region.

The head-mounted display device may use a set of optical systems (mainly precision optical lenses) to magnify an image on an ultra-micro display screen, project the image on a retina, and then present the large-screen image in eyes of a viewer, like viewing an object with a magnifying glass to present a magnified image of the virtual object. Different effects such as virtual reality (VR), augmented reality (AR), or mixed reality (MR) may be realized by sending optical signals to the user's eyes through the head-mounted display device. For normal display devices, the user needs to look at the device. For this head-mounted display device, the user may not need to look at the device. Further, since the head-mounted display device is usually in the shape of a hat or glasses, it may be easy to carry and be used at any time. Since a small display screen is used, it may be very power-saving. Especially when a large virtual display is formed, a significant energy-saving effect may be achieved.

In the application scenario involving the unmanned aerial vehicle, the remote controller, and the head-mounted display device, the user may send the control stick value through the remote controller. The unmanned aerial vehicle may determine the target image region in the panoramic image captured by the photographing device after receiving the control stick value, and then send the target image region to the head-mounted display device. After receiving the target image region, the head-mounted display device may display the target image region, and the user may be able to immersively view the target image region.

In some other embodiments, the method provided by the present disclosure may be applied in an application scenario involving an unmanned aerial vehicle, a remote controller, and a terminal device. That is, the control device may include the remote controller and the terminal device. In this scenario, obtaining the control stick value sent by the control device (S101) may include: obtaining the control stick value sent by the remote controller. Correspondingly, sending the target image region to the control device such that the control device displays the target image region (S103) may include: sending the target image region to the terminal device, such that the terminal device displays the target image region.

The terminal device may include, but is not limited to: a smartphone, a ground control station, a PC, a PDA, etc. For example, a user's mobile phone may have an application program installed therein, and the user may send the control stick value through the remote controller. The unmanned aerial vehicle may determine the target image region in the panoramic image captured by the photographing device after receiving the control stick value, and then send the target image region to the user's mobile phone. After receiving the target image region, the user's mobile phone may display the target image region in the screen of the mobile phone, and the user may be able to view the target image region. In some embodiments, the unmanned aerial vehicle may send the target image region to the remote controller through a private communication link, and the remote controller may forward the target image region to the mobile phone. For example, the remote controller may forward the target image region to the mobile phone through a connection line. In another example, the unmanned aerial vehicle may send the target image region directly to the mobile phone through a standard communication link, such as WIFI, 4G, etc.

In some other embodiments, the method provided by the present disclosure may be applied in an application scenario involving an unmanned aerial vehicle and a control device including a control area and a display area. That is, the control device may be provided with the control area and the display area. In this scenario, obtaining the control stick value sent by the control device (S101) may include: obtaining the control stick value sent by the remote controller, where the control stick value may be generated according to a user's operation in the control area. Correspondingly, sending the target image region to the control device such that the control device displays the target image region (S103) may include: sending the target image region to the control device, such that the control device displays the target image region in the display area.

In some embodiments, the control device may be provided with the control area and the display area. The control area may be configured for the user to operate for generating and sending the control stick value. The display area may be configured for displaying. The user may generate and send the control stick value based on the control area of the control device. The unmanned aerial vehicle may determine the target image region in the panoramic image captured by the photographing device after receiving the control stick value, and then send the target image region to the control device. After receiving the target image region, the control device may display the target image region in the display area, and the user may be able to view the target image region.

FIG. 7 shows an example of determining the target image region in the panoramic image captured by the photographing devices according to the control stick value (i.e., S102 in FIG. 1).

As shown in FIG. 7, at S1021, a virtual attitude angle to which the control stick value maps is determined according to the control stick value. At S1022, the target image region is determined according to the virtual attitude angle.

The virtual attitude angle may be an imaginary and virtual attitude angle. The virtual attitude angle may include at least one of a pitch angle, a yaw angle, or a roll angle. The virtual attitude angle may be used to determine the target image region in the panoramic image. In some embodiments, the target image region may be not directly determined according to the control stick value, but the virtual attitude angle may be mapped according to the control stick value and then the target image region may be determined according to the virtual attitude angle. Therefore, the method of determining the target image region may be more intuitive, flexible, diverse, and convenient, to better meet various needs of users.

In some embodiments, determining the target image region according to the virtual attitude angle (S1022) may include: determining the target image region according to a preset FOV and the virtual attitude angle.

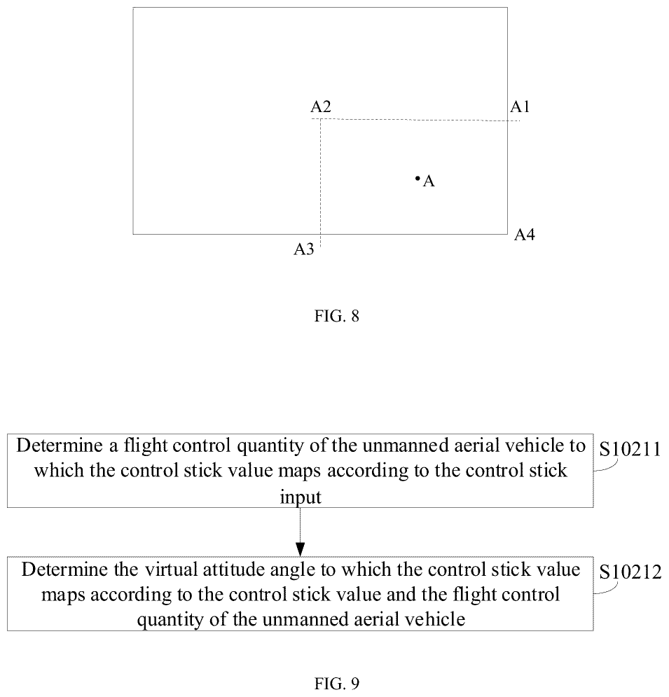

An FOV is also called a view field in optical engineering. The size of the FOV determines the view field of an optical instrument. The larger the FOV, the larger is the view field. In some embodiments, the preset FOV may be used to determine the range of the target image region in the panoramic image. The virtual attitude angle may be used to determine the center of the target image region. As shown in FIG. 8, the solid line box in the figure indicates the panoramic image, center A of the target image region is determined according to the virtual attitude angle, and the preset FOV is used to determine the range of the target image region in the panoramic image. In the figure, the box formed by A1, A2, A3, and A4 indicates the range of the target image region.

Since the range of the target image region could be determined according to the preset FOV and the center of the target image region could be determined according to the virtual attitude angle, the target image region may be determined quickly and accurately.

In some embodiments, the virtual attitude angle to which the control stick value maps may be related to a flight control quantity of the unmanned aerial vehicle to which the control stick value maps. Since the control stick value may map to the flight control quantity of the unmanned aerial vehicle besides the virtual attitude angle, the virtual attitude angle to which the control stick value maps may be related to the flight control quantity of the unmanned aerial vehicle. Therefore, the target image region determined according to the virtual attitude angle may be related to the flight process of the unmanned aerial vehicle, such that the user is able to view the target image region of the unmanned aerial vehicle during the flight in time and have the immersive flight experience of FPV.

FIG. 9 shows an example of determining the virtual attitude angle to which the control stick value maps according to the control stick value (i.e., S1021 in FIG. 7). As shown in FIG. 9, at S10211, the flight control quantity of the unmanned aerial vehicle to which the control stick value maps is determined according to the control stick value. At S10212, the virtual attitude angle to which the control stick value maps is determined according to the control stick value and the flight control quantity of the unmanned aerial vehicle.

In some embodiments, the virtual attitude angle to which the control stick value maps may be related to both the control stick value and the flight control quantity of the unmanned aerial vehicle to which the control stick value maps. Correspondingly, the target image region determined according to the virtual attitude angle may be related to both the control stick value and the flight control quantity of the unmanned aerial vehicle to which the control stick value maps. That is, the user may be able to further control the target image region through the control stick during the flight process of the unmanned aerial vehicle, such that the user is able to view the target image region that the user further wants to see during the flight of the unmanned aerial vehicle in time.

In some embodiments, determining the flight control quantity of the unmanned aerial vehicle to which the control stick value maps according to the control stick value (S10211) may include: determining the flight control quantity of the unmanned aerial vehicle according to the control stick value and a preset virtual aircraft control model. The preset virtual aircraft control model may include a correspondence relationship between the control stick value and the flight control quantity of the unmanned aerial vehicle.

In some embodiments, the preset virtual aircraft control model may be provided in advance. The preset virtual aircraft control model may include the correspondence relationship between the control stick value and the flight control quantity of the unmanned aerial vehicle. The flight control quantity of the unmanned aerial vehicle may be determined according to the received control stick value and the correspondence relationship between the control stick value and the flight control quantity of the unmanned aerial vehicle. Correspondingly, the user may be able to experience the flight experience of the preset aircraft control model other than the current unmanned aerial vehicle. For example, in some embodiments, the preset aircraft control model may include a preset virtual FPV aircraft control model, and the user may be able to experience the flight experience of an FPV unmanned aerial vehicle. In some other embodiments, the preset virtual aircraft control model may include a preset virtual aerial photography aircraft control model, and the user may be able to experience the flight experience of an aerial photography unmanned aerial vehicle.

In some embodiments, the control stick value may include a first control stick value and a second control stick value. Therefore, determining the flight control quantity of the unmanned aerial vehicle to which the control stick value maps according to the control stick value (S10211) may include: determining a first flight control quantity of the unmanned aerial vehicle for flying upwards or downwards in the vehicle body coordinate system according to the first control stick value; and determining a second flight control quantity of the unmanned aerial vehicle for flying forwards or backwards in the vehicle body coordinate system according to the second control stick value.

In some embodiments, the first control stick value may be configured to control the unmanned aerial vehicle to fly upwards or downwards, and the second control stick value may be configured to control the unmanned aerial vehicle to fly forwards or backwards.

Correspondingly, the first control stick and the second control stick value may be used to control the unmanned aerial vehicle to fly upwards or downwards, or to fly forwards or backwards.

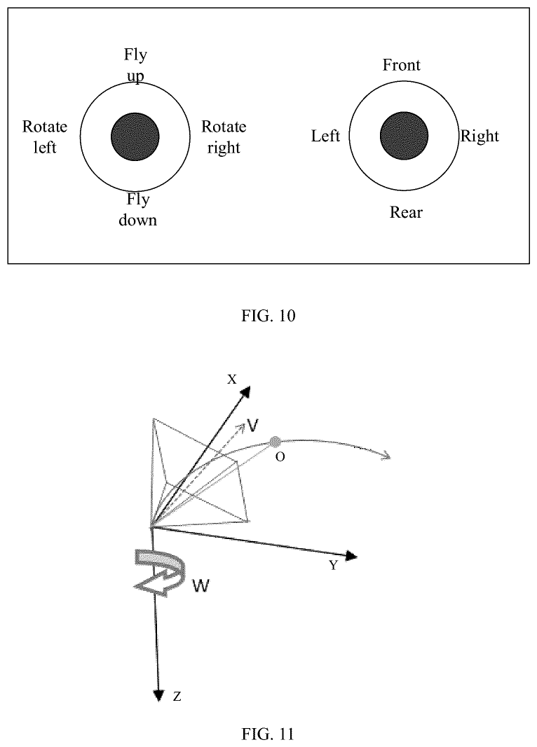

FIG. 10 schematically shows an example remote controller, in which the left solid circle represents a left joystick and the right solid circle represents a right joystick. The unmanned aerial vehicle flight control corresponding to the four stick values in the remote controller is described in more detail below.
(1) The left joystick may function as a throttle joystick when being moved up or down. The throttle joystick is used to control ascending and descending of the unmanned aerial vehicle. When the throttle joystick is pushed up, the unmanned aerial vehicle may fly up; and when the throttle joystick is pushed down, the unmanned aerial vehicle may fly down. When the throttle joystick locates at the middle position, the height of the unmanned aerial vehicle may remain unchanged.
(2) The left joystick may function as a yaw joystick when being moved left or right. The yaw stick is used to control the flight direction of the unmanned aerial vehicle. When the yaw joystick is pushed left, the unmanned aerial vehicle may rotate left (that is, rotate counterclockwise); and when the yaw joystick is pushed right, the unmanned aerial vehicle may rotate right (that is, rotate clockwise). When the yaw joystick locates at the middle position, the rotating angular speed may be zero, and the unmanned aerial vehicle may not rotate.
(3) The right joystick may function as a pitch joystick when being moved left or right. The pitch stick is used to control the unmanned aerial vehicle to fly forwards or backwards. When the pitch joystick is pushed up, the unmanned aerial vehicle may fly upwards; and when the pitch joystick is pushed down, the unmanned aerial vehicle may fly backwards. When the pitch joystick locates at the middle position, the unmanned aerial vehicle may keep horizontal in the front and rear direction.
(4) The right joystick may function as a roll joystick when being moved left or right. The roll stick is used to control the unmanned aerial vehicle to fly left or right. When the roll joystick is pushed left, the unmanned aerial vehicle may fly left (that is, move left translationally); and when the roll joystick is pushed right, the unmanned aerial vehicle may fly right (that is, move right translationally). When the roll joystick locates at the middle position, the unmanned aerial vehicle may remain horizontal in the left and right direction.

In the remote controller in some embodiments, the stick value issued by the throttle joystick may be referred to as the first control stick value, and the stick value issued by the pitch joystick may be referred to as the second control stick value.

The first control stick value and the second control stick value may be speed control quantities.

In some embodiments, the control stick value may further include a third control stick value. In this scenario, determining the virtual attitude angle to which the control stick value maps according to the control stick value and the flight control quantity of the unmanned aerial vehicle (S10212) may include determining a yaw angle in the virtual attitude angle according to the third control stick value; and determining a pitch angle in the virtual attitude angle according to the first flight control quantity and the second flight control quantity.

The pitch angle in the virtual attitude angle may be related to the first flight control quantity and the second flight control quantity. The yaw angle in the virtual attitude angle may be determined according to another third control stick value. In this way, the virtual attitude angler that is able to meet the needs of the user may be obtained, to obtain the target image region that is able to better meet the needs of the user.

In some embodiments, after the yaw angle in the virtual attitude angle is determined according to the third control stick value, a prediction may be performed on the movement trajectory of the unmanned aerial vehicle to obtain a predicted trajectory of the unmanned aerial vehicle, a yaw offset angle may be determined according to the predicted trajectory and the yaw angle in the virtual attitude angle may be adjusted according to the yaw offset angle.

In some embodiments, the movement trajectory of the unmanned aerial vehicle may be predicted and the yaw offset angle may be obtained based on the predicted trajectory. Then the yaw angle in the virtual attitude angle may be adjusted according to the yaw offset angle. In this way, the yaw angle in the virtual attitude angle may be made as consistent with the yaw angle of the user's desire as possible, to improve the user experience.

In some embodiments, determining the yaw offset angle according to the predicted trajectory may include obtaining a preset forward-looking time, determining a target trajectory point in the predicted trajectory according to the preset forward-looking time, and determining the yaw offset angle according to the target trajectory point.

As shown in FIG. 11, in some embodiments, in the vehicle body coordinate system, the unmanned aerial vehicle is able to fly forward and backward in the X-axis direction, fly up and down in the Z-axis direction, or rotate around the Z axis at angular speed W. Based on speed Vx, Vy, Vz, and W, the future trajectory of the unmanned aerial vehicle may be predicted, to obtain the predicted trajectory (the curve indicated by the solid line arrow in the figure is the predicted trajectory). The preset forward-looking time t is T, and the target trajectory point in the predicted trajectory is point O. Therefore, the yaw offset angle may be determined according to the target trajectory point O, and the yaw angle in the virtual attitude angle may be adjusted according to the yaw offset angle.

In this way, in the turning process of the unmanned aerial vehicle, the virtual attitude angle (the attitude angle indicated by the vertebral body in the figure) may be made facing the future trajectory of the unmanned aerial vehicle. Similar to a drive scenario where the user, when turning, often looks at the post-turning region, in some embodiments, the movement trajectory of the unmanned aerial vehicle may be predicted to obtain the predicted trajectory, and the yaw offset angle may be obtained based on the predicted trajectory. Then the yaw angle in the virtual attitude angle may be adjusted according to the yaw offset angle. Correspondingly, the target image region determined according to the virtual attitude angle may be more in line with user's habits.

In some embodiments, determining the virtual attitude angle to which the control stick value maps according to the control stick value (S1021) may further include determining the virtual attitude angle in the virtual camera coordinate system according to the control stick value.

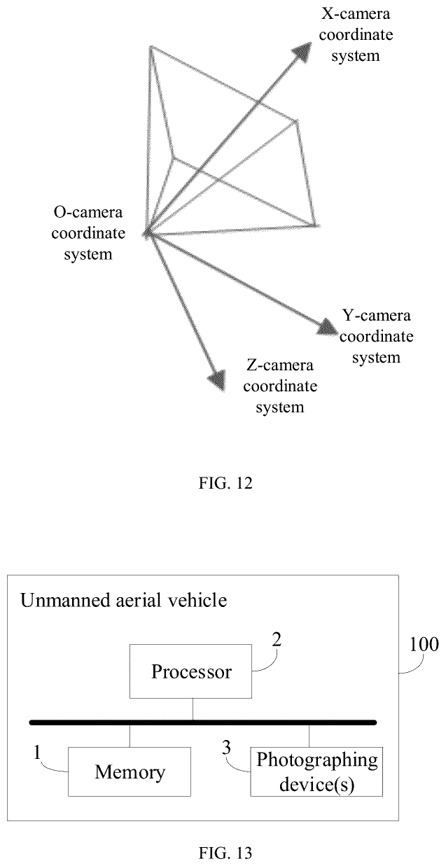

As shown in FIG. 12, in some embodiments, the original point, X axis, Y axis, and Z axis of the virtual camera coordinate system are defined in advance. Also, the correspondence relationship between the control stick value and the attitude angles in the virtual camera coordinate system is defined. The virtual attitude angle in the virtual camera coordinate system is determined according to the received control stick value. Therefore, the virtual attitude angle and the flight control quantity of the unmanned aerial vehicle may be decoupled, and users may be able to determine the virtual attitude angle of the control stick value in the virtual camera coordinate system according to their own wishes, and then to determine the target image region.

The present disclosure also provides an unmanned aerial vehicle. FIG. 13 is a schematic structure of an unmanned aerial vehicle provided by one embodiment of the present disclosure. The unmanned aerial vehicle is able to execute processes in the control method of the unmanned aerial vehicle provided by various embodiments of the present disclosure, and the related content may be made reference to the previous description about the control method of the unmanned aerial vehicle.

As shown in FIG. 13, in some embodiments, one or more photographing devices 3 are provided at the unmanned aerial vehicle 100, and are used to capture a panoramic image. The unmanned aerial vehicle 100 is in communication connection with a control device. The unmanned aerial vehicle 100 also includes: a memory 1 and a processor 2. The processor 2 is connected with the memory 1 and the photographing devices 3 through a bus.

The processor 2 may be, for example, a microcontroller unit, a central processing unit, or a digital signal processor.

The memory 1 may be, for example, a flash chip, a read only memory, a magnetic disk, an optical disk, a flash drive, or a mobile hard disk.

The memory 1 is used to store a computer program. The processor 2 is used to execute the computer program, and when the computer program is executed, to implement the following processes when the computer program is executed: obtaining a control stick value sent by the control device; according to the control stick value, determining a target image region in a panoramic image captured by the photographing devices; and sending the target image region to the control device to make the control device display the target image region.

In some embodiments, the control device may include a remote controller and a head-mounted display device. When executing the computer program, the processor may be configured to implement the following processes: obtaining the control stick value sent by the remote controller; sending the target image region to the head-mounted display device, such that the head-mounted display device displays the target image region.

In some embodiments, the control device may include a remote controller and a terminal device. When executing the computer program, the processor may be configured to implement the following processes: obtaining the control stick value sent by the remote controller; sending the target image region to the terminal device, such that the terminal device displays the target image region.

In some embodiments, the control device may be provided with a control area and a display area. When executing the computer program, the processor may be configured to implement the following processes: obtaining the control stick value sent by the control device, where the control stick value is generated based on a user's operation in the control area; and sending the target image region to the control device, such that the display area of the control device displays the target image region.

In some embodiments, when executing the computer program, the processor may be configured to: determine a virtual attitude angle to which the control stick value maps according to the control stick value; and determine the target image region according to the virtual attitude angle.

In some embodiments, when executing the computer program, the processor may be configured to: determine the target image region according to a preset FOV and the virtual attitude angle.

In some embodiments, the virtual attitude angle to which the control stick value maps may be related to a flight control quantity of the unmanned aerial vehicle to which the control stick value maps.

In some embodiments, when executing the computer program, the processor may be configured to: determine the flight control quantity of the unmanned aerial vehicle to which the control stick value maps according to the control stick value; and determine the virtual attitude angle to which the control stick value maps according to the control stick value and the flight control quantity of the unmanned aerial vehicle.

In some embodiments, when executing the computer program, the processor may be configured to: determine the flight control quantity of the unmanned aerial vehicle according to the control stick value and a preset virtual aircraft control model, where the preset virtual aircraft control model may include a correspondence relationship between the flight control quantity of the unmanned aerial vehicle and the control stick value.

In some embodiments, the preset virtual aircraft control model may include a preset virtual FPV aircraft control model.

In some embodiments, the control stick value may include a first control stick value and a second control stick value. Therefore, when executing the computer program, the processor may be configured to: determine a first flight control quantity of the unmanned aerial vehicle for flying upwards or downwards in the vehicle body coordinate system according to the first control stick value; and determine a second flight control quantity of the unmanned aerial vehicle for flying forwards or backwards in the vehicle body coordinate system according to the second control stick value.

In some embodiments, the control stick value may further include a third control stick value. Therefore, when executing the computer program, the processor may be configured to: determine a yaw angle in the virtual attitude angle according to the third control stick value; and determine a pitch angle in the virtual attitude angle according to the first flight control quantity and the second flight control quantity.

In some embodiments, the first control stick value and the second control stick value may be speed control quantities.

In some embodiments, when executing the computer program, the processor may be configured to: perform prediction on the movement trajectory of the unmanned aerial vehicle to obtain the predicted trajectory of the unmanned aerial vehicle; determine a yaw offset angle according to the predicted trajectory; and adjust the yaw angle in the virtual attitude angle according to the yaw offset angle.

In some embodiments, when executing the computer program, the processor may be configured to: obtain a preset forward-looking time; determine a target trajectory point in the predicted trajectory according to the preset forward-looking time; and determine the yaw offset angle according to the target trajectory point.

In some embodiments, when executing the computer program, the processor may be configured to: determine the virtual attitude angle in the virtual camera coordinate system according to the control stick value.

In some embodiments, the photographing devices may include one or more photographing devices.

In some embodiments, the unmanned aerial vehicle may include a first arm and a second arm. The second arm may be connected to the first arm through a rotation shaft. The photographing devices may be disposed at two ends of the rotation shaft. The photographing devices may be fisheye photographing devices.

The present disclosure also provides a computer-readable storage medium. The computer-readable storage medium may be configured to store a computer program. When the computer program is executed by a processor, the control method of the unmanned aerial vehicle provided by various embodiments of the present disclosure may be implemented.

The computer-readable storage medium may be an internal storage unit of the unmanned aerial vehicle described in any of the foregoing embodiments of the present disclosure, such as a hard disk or a memory of the device. The computer-readable storage medium may also be an external storage device of the device, such as a plug-in hard disk equipped on the device, a smart memory card (SMC), a secure digital card (SD), or a flash card, etc.

The terminology used in the present disclosure is for the purpose of describing particular embodiments only and is not intended to limit the scope of the present disclosure.

The term “and/or” used in the present disclosure and the appended claims refers to any combination of one or more of the associated listed items and all possible combinations, and includes these combinations.

The above are only specific implementations of embodiments of the present disclosure, but the scope of the present disclosure is not limited to this. One of ordinary skill in the art can easily think of various equivalents within the technical scope disclosed in the present disclosure. These modifications or replacements shall be included within the scope of the present disclosure. Therefore, the protection scope of the present invention shall be subject to the protection scope of the claims.

What is claimed is:

1. A control method for an aerial vehicle comprising:
obtaining a control stick value sent by a control device in communication connection with the aerial vehicle;
determining, according to the control stick value, a target image region in a panoramic image captured by one or more photographing devices carried by the aerial vehicle; and
sending the target image region to the control device, to enable the control device to display the target image region.

2. The method according to claim 1, wherein:
the control device includes a remote controller and a head-mounted display device;
obtaining the control stick value sent by the control device includes obtaining the control stick value sent by the remote controller; and
sending the target image region to the control device to enable the control device to display the target image region includes sending the target image region to the head-mounted display device, to enable the head-mounted display device to display the target image region.

3. The method according to claim 1, wherein:
the control device includes a remote controller and a terminal device;
obtaining the control stick value sent by the control device includes obtaining the control stick value sent by the remote controller; and
sending the target image region to the control device to enable the control device to display the target image region includes sending the target image region to the terminal device, to enable the terminal device to display the target image region.

4. The method according to claim 1, wherein:
the control device includes a control area and a display area;
obtaining the control stick value sent by the control device includes obtaining the control stick value sent generated based on a user operation in the control area; and
sending the target image region to the control device to enable the control device to display the target image region includes sending the target image region to the control device, to enable the display area of the control device to display the target image region.

5. The method according to claim 1, wherein determining the target image region in the panoramic image captured by the photographing devices according to the control stick value includes:
determining, according to the control stick value, a virtual attitude angle to which the control stick value maps; and
determining the target image region according to the virtual attitude angle.

6. The method according to claim 5, wherein determining the target image region according to the virtual attitude angle includes determining the target image region according to a preset field of view and the virtual attitude angle.

7. The method according to claim 5, wherein the virtual attitude angle to which the control stick value maps is related to a flight control quantity of the aerial vehicle to which the control stick value maps.

8. The method according to claim 5, wherein:
the aerial vehicle is an unmanned aerial vehicle; and
determining the virtual attitude angle to which the control stick value maps according to the control stick value includes:
determining, according to the control stick value, a flight control quantity of the unmanned aerial vehicle to which the control stick value maps; and
determining the virtual attitude angle to which the control stick value maps according to the control stick value and the flight control quantity of the unmanned aerial vehicle.

9. The method according to claim 8, wherein determining, according to the control stick value, the flight control quantity of the unmanned aerial vehicle to which the control stick value maps includes:
determining the flight control quantity of the unmanned aerial vehicle according to the control stick value and a preset virtual aircraft control model, the preset virtual aircraft control model including a correspondence relationship between the flight control quantity of the unmanned aerial vehicle and the control stick value.

10. The method according to claim 9, wherein the preset virtual aircraft control model includes a preset virtual first-person view aircraft control model.

11. The method according to claim 8, wherein:
the control stick value includes a first control stick value and a second control stick value; and
determining, according to the control stick value, the flight control quantity of the unmanned aerial vehicle to which the control stick value maps includes:
determining, according to the first control stick value, a first flight control quantity of the unmanned aerial vehicle for flying upwards or downwards in a vehicle body coordinate system; and
determining, according to the second control stick value, a second flight control quantity of the unmanned aerial vehicle for flying forwards or backwards in the vehicle body coordinate system.

12. The method according to claim 11, wherein:
the control stick value further includes a third control stick value; and
determining, according to the control stick value, the flight control quantity of the unmanned aerial vehicle to which the control stick value maps further includes:
determining a yaw angle in the virtual attitude angle according to the third control stick value; and
determining a pitch angle in the virtual attitude angle according to the first flight control quantity and the second flight control quantity.

13. The method according to claim 12, wherein the first control stick value and the second control stick value are speed control quantities.

14. The method according to claim 12, further comprising, after determining the yaw angle in the virtual attitude angle according to the third control stick value:
performing prediction on a movement trajectory of the unmanned aerial vehicle to obtain a predicted trajectory of the unmanned aerial vehicle;
determining a yaw offset angle according to the predicted trajectory; and
adjusting the yaw angle in the virtual attitude angle according to the yaw offset angle.

15. The method according to claim 14, wherein determining the yaw offset angle according to the predicted trajectory includes:
obtaining a preset forward-looking time;
determining a target trajectory point in the predicted trajectory according to the preset forward-looking time; and
determining the yaw offset angle according to the target trajectory point.

16. The method according to claim 5, wherein determining, according to the control stick value, the virtual attitude angle to which the control stick value maps includes:
determining the virtual attitude angle in a virtual camera coordinate system according to the control stick value.

17. The method according to claim 1, wherein the one or more photographing devices include a plurality of photographing devices.

18. The method according to claim 17, wherein:
the unmanned aerial vehicle includes a first arm and a second arm connected to each other through a rotation shaft; and
the photographing devices include fisheye photographing devices disposed at two ends of the rotation shaft.

19. An aerial vehicle comprising:
one or more photographing device configured to capture a panoramic image;
a memory storing a computer program; and
a processor configured to execute the computer program to:
obtain a control stick value sent by a control device in communication connection with the aerial vehicle;
determine a target image region in the panoramic image according to the control stick value; and
send the target image region to the control device, to enable the control device to display the target image region.

20. The aerial vehicle according to claim 19, wherein:
the control device includes a remote controller and a head-mounted display device; and
the processor is further configured to execute the computer program to:
obtain the control stick value sent by the remote controller; and
send the target image region to the head-mounted display device, to enable the head-mounted display device to display the target image region.
